(19) United States
(12) Patent Application Publication
(10) Pub. No.: US 2002/0039114 A1
(43) Pub. Date: Apr. 4, 2002

(54) Method and system of navigating using a graphical portal

(76) Inventors: Kirk Feathers, Ballston, NY (US); Lisa Popp, Johnsonville, NY (US); Brian McDermott, Salem, NY (US)

Correspondence Address: BUCHANAN INGERSOLL, P.C., 301 GRANT STREET, 20TH FLOOR, PITTSBURGH, PA, 15219

(21) Appl. No.: 09/682,631

(22) Filed: Oct. 1, 2001

Related U.S. Application Data
(60) Provisional application No. 60/236,612, filed on Sep. 29, 2000.

(51) Int. Cl. G06F 3/00

(52) U.S. Cl. 345/738

(57) ABSTRACT

A novel method of navigating the Internet is disclosed. Hyperlinks to web sites are grouped and displayed using the paradigm of shops in a town or village setting. Buildings in the town represent a collection of hyperlinks having a common theme. Buildings can be grouped together into districts representing common concepts, such as retail establishments, banks, restaurants, etc. Additionally, towns from various different cultures can be presented, having culturally localized web sites associated therewith.

### RELATED APPLICATIONS

Referenced-Applications

This Application claims the benefit of U.S. Provisional Application, Serial No. 60/236,612, filed Sep. 29, 2000.

### FIELD OF THE INVENTION

The present invention relates to a method and system for navigating on the Internet using a graphical portal. More particularly, to using a plurality of graphical images to provide navigational linkage among a plurality of internet sites.

### BACKGROUND OF THE INVENTION

When navigating around the Internet, a user is typically limited to a set of words or images that can transfer the user among pages of a web site or to and from different web sites. The basis of this navigation technique is the hyperlink technology that was developed for the Internet and which is well known in the art.

FIG. 1 illustrates a typical Internet network 100 wherein user 110 communicates with a plurality of servers, as represented by server 120, server 130 and server 140. Each of the illustrated servers includes information items, e.g., web site pages, that user 110 desires to view, to study or to purchase items from. Using, as an example, server 120, as a host server, user 110 can access information items on each of the illustrated servers by inputting an appropriate server address. For example, user 110 may input an address, i.e., a Universal Resource Locator (URL), that is representative of a web site located on either of servers 110, 120 or 130. Hence, by inputting the address of each different web site page the user wishes to view, the user is directed to the server containing the desired information. This type of navigation is rudimentary and imposes upon user 110 the need to know or recall the address of each web site page the user desires to view or has previously viewed. In those cases in which the web site has linked web pages, the burden on user 110 in navigating to other web pages is reduced by using the Internet hypertext protocol language to “transfer” to another web page. Accordingly, hypertext linking allows the user to use key words and graphic images, i.e., hot spots, on the web site page which interpret the user's actions as inputting a designated web site address. FIG. 2 illustrates a typical web site page 200 containing exemplary implementations of keywords and graphic images. For example, banner 210 and buttons 212 and 220 are graphic images that direct a user to different web site pages when the user executes the proper procedure, for example, by placing a cursor over the image and selecting the image by, for example, clicking a button on a mouse.

Similarly, linking addresses may be designated by key words, such as those illustratively labeled “Feature 1” 247, “Feature 2” 250, “Book 1” 257, “List1” 280, “Store 2” 290, etc. Key words are typically distinguished from textual information, for example, as represented by the lettering within block 230, by presenting key words in a blue lettering and underlined. Blue lettering and underlining is a typical indication that specific wording is a key word, and is thus associated with a URL.

FIG. 3a illustrates an exemplary web site page which is displayed when a hyperlink included within image 275 of FIG. 2, for example, is activated. In this exemplary web site page, image 275, is increased in size and includes additional information items concerning the enlarged image 275. In this illustrative example, the textual words within block 310 are included on the web site page. Further, blocks 320 and 325 include information items, i.e., images, keyword, hot spots, text, etc., that can be different than the information items on previous web site page. This additional information enables the user to link to still other web site pages. In this illustrative example, key word “Book2” 260 is included within block 325 and would direct a user to another web site page containing information on Book 2. FIG. 3b illustrates a second exemplary web site page that a user is able to view when the user double clicks key word “Book 2” 260 illustrated in FIG. 3a, similar to FIG. 3a, containing information items, i.e., keywords, images, etc., that directs the user to still further web site pages. It would be appreciated that the user is also directed to the second exemplary web site page of FIG. 3b, when the user selects key word “Book 2” 260, illustrated in FIG. 2. Thus, an Internet user is afforded the opportunity to continually link within or among web site pages from different web site pages. This continual linking is termed deep-linking, as the user is continually extending deeper into a single web site or among a plurality of associated web sites.

Using the well known navigation techniques just described, the Internet makes information from all over the world available just as readily as information that can be accessed using local resources. While the breadth and depth of this easily accessible information makes the Internet the premiere research and communications tool of the modern age, the unique cultural origins of individual web pages are not generally easy to discern. For English-speaking web users, it is frequently only the pages written in a language other than English that can be clearly identified as coming from a distinctly different culture. While there is a certain appeal to the fact that all pages that fit a particular search criterion are presented without any cultural filtering, it is difficult for the average web user to positively experience the cultural differences that can add richness and context to the information that they seek.

Some web pages or portals offer users the choice of viewing a particular page or portions of a web site in a different language, but these linguistic changes are generally text-based rather than graphical, and do not necessarily enhance any understanding of the underlying culture. Furthermore, the success of a web page depends on the amount of traffic that it is able to generate and sustain. Web users are looking for a combination of factors, such as ease of navigation, informative content, and interesting and engaging presentation.

Therefore, it would be desirable to provide a graphical portal to web pages that are commonly accessed and/or which are discovered through various searches. The graphical portal would ideally use a paradigm familiar to most users from real-life experiences to promote comfort, ease of use and familiarity for the user, as well as providing a cultural context in which users can view various web pages.

### SUMMARY OF THE INVENTION

A method of accessing a plurality of web site pages is presented that organizes and visually presents representations of Internet hyperlink addresses associated with corresponding web site pages by graphically displaying a town or village setting wherein the town or village is composed of a plurality of buildings which contain therein representations of categories of information items, such as retail and commercial establishments, having a common theme. The displayed buildings are further collected together within districts, based on their proximity to each other in the town, wherein the districts are representative of a common concept among the buildings contained therein, much as would be the case in a real town or village. Further, to enhance the cultural distinctions between different groups of web sites, for example, web sites originating in Europe or Africa, different types of towns can be displayed, such as a European town or an African village respectively. This lends a cultural context to the web experience that is lacking in the text-based or homogenous web pages, which lack cultural diversity.

The organization of the web site pages affords the user a concise access to common web site pages based on typical user life experiences. Further, a user may navigate among retail and commercial establishments that have a common theme and then can easily return to a familiar reference to begin a different navigation sequence. Lastly, culturally localized web sites are grouped together under a portal page which is also culturally-localized to provide the proper context for the viewing of the web pages.

### BRIEF DESCRIPTION OF THE DRAWINGS

FIG. 1 illustrates an exemplary network configuration;

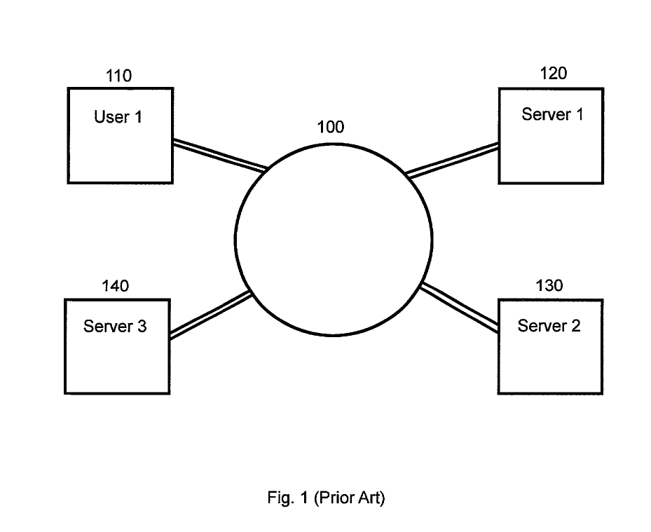

FIG. 2 illustrates an exemplary Internet web site page;

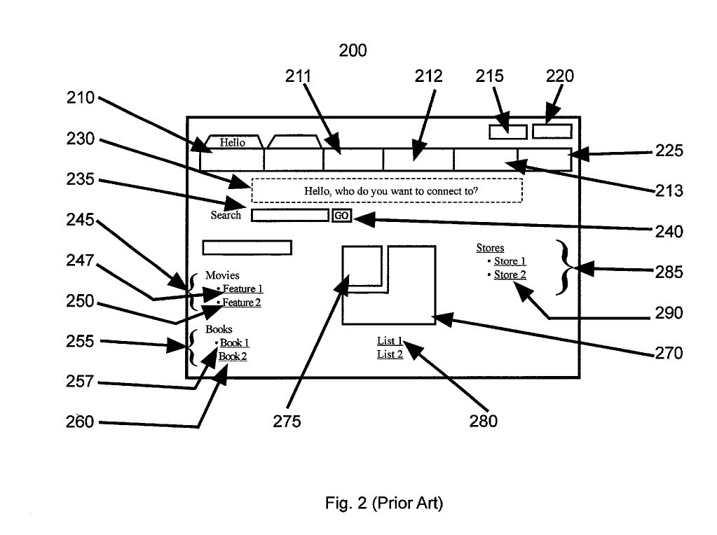

FIG. 3a illustrates an exemplary Internet web site page linked to the web site page illustrated in FIG. 2;

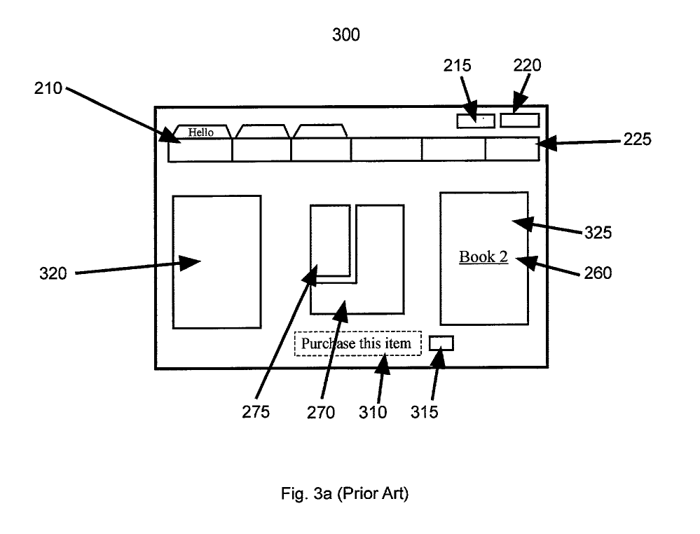

FIG. 3b illustrates a second exemplary Internet web site page linked to the web site page illustrated in FIG. 2;

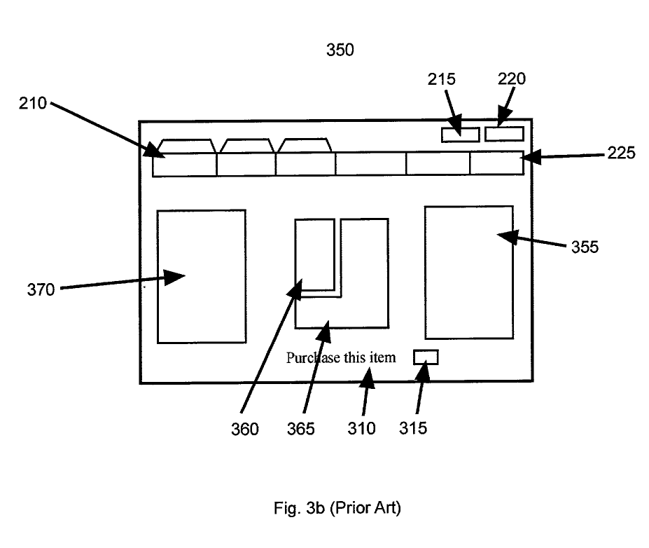

FIG. 4 illustrates an exemplary web site page in accordance to the principles of the invention;

FIG. 5a illustrates a district on the exemplary web site page illustrated in FIG. 4 in accordance with the principles of the invention;

FIG. 5b illustrates an exemplary category selected on the web site page illustrated in FIG. 4 in accordance with the principles of the invention;

FIG. 6 illustrates a second exemplary category selected on the web site page illustrated in FIG. 4 in accordance with the principles of the invention;

FIG. 7 illustrates an exemplary web site page linked to the web site page illustrated in FIG. 5a in accordance with the principles of the invention;

FIG. 8 illustrates another exemplary web site page in accordance with the principles of the invention.

FIG. 9 illustrates another exemplary web site page in accordance with the principles of the invention;

FIG. 10 illustrates a second embodiment of an exemplary web site page linked to the web site page illustrated in FIG. 5a in accordance with the principles of the invention;

FIG. 11a illustrates an exemplary web site page illustrating a dynamically updated information item, in accordance to the principles of the invention; and

FIG. 11b illustrates a second exemplary web site page illustrating a dynamically updated information item, in accordance to the principles of the invention.

It is to be understood that these drawings are solely for purposes of illustrating the concepts of the invention and are not intended as a definition of the limits of the invention. It will be appreciated that the same reference numerals, possibly supplemented with reference characters where appropriate, have been used throughout to identify corresponding parts.

### DETAILED DESCRIPTION OF THE INVENTION

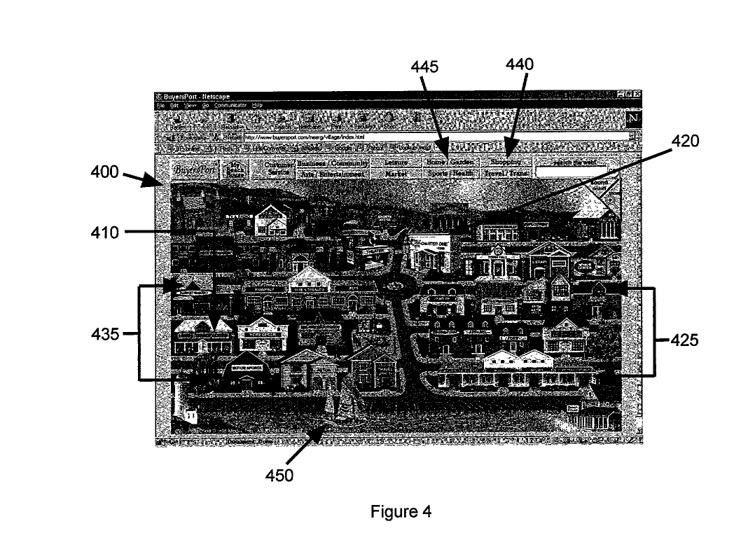

FIG. 4 illustrates an exemplary representation of a portal web page in accordance with the principles of the invention. In this illustrative example, web page 400 is created using a familiar town or village setting. The town or village is presented by buildings that are representative of typical real-world retail and commercial establishments found in a town or village. For example, building 410 is a representative depiction of a Lawn and Garden Center, whereas building 420 is a representative depiction of a bank. Hence, at least one web site page having access to Lawn and Garden Equipment or supplies is accessible, i.e., linked to, when Lawn and Garden building 410 is entered. Similarly, at least one bank is accessible when the bank building 420 is entered.

In another aspect of the invention, the appearance of the town may be changed to provide a cultural context to the web experience. A button may be provided on the interface, such as, for example, button 450 in FIG. 4, depicted as a sailboat and labeled, “Across the Pond.” This button can bring up a list of culturally localized portal web pages which act as hosts for a variety of web pages which can be grouped together by culture. Once the user selects one of the culturally localized web portal pages, a graphical interface using the town paradigm which is culturally distinct from the typical American town shown in FIG. 4, such as a European town or an African village is displayed. Such a portal will have links to web pages which have origins in those distinct cultures depicted and will be “themed” to give an impression of the selected culture by showing. This can be accomplished by showing the types of buildings which may be found in that particular culture, having culture-specific decorations on the page or playing culture-specific music as the portal page is viewed. The culturally localized portal pages therefore provide a context for viewing the linked web pages.

On each portal page, the illustrated retail and commercial establishments having a common concept are grouped together into districts to facilitate a user's experience on the web site. For example, retail or commercial establishments associated with consumer retail goods are grouped together in retail shopping district 425, whereas retail establishment associated with home products are grouped together in shopping district 435. This visual presentation conveys to the user information concerning the type of data items within a district. Thus, rather than organizing information content into somewhat related individual keywords or images, the visual relationships developed from life experiences are incorporated into the web site navigation.

Illustrated further is navigation bar 440, which can be used to select retail or commercial establishments by labeled designation. For example, establishments associated with home/garden can be selected by activating home/garden designation 445.

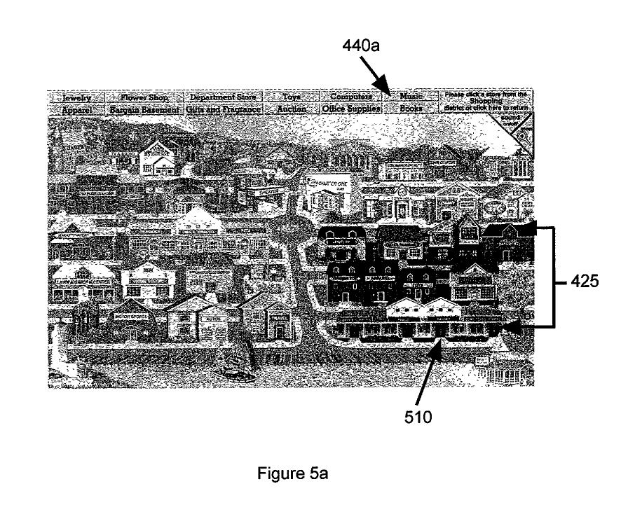

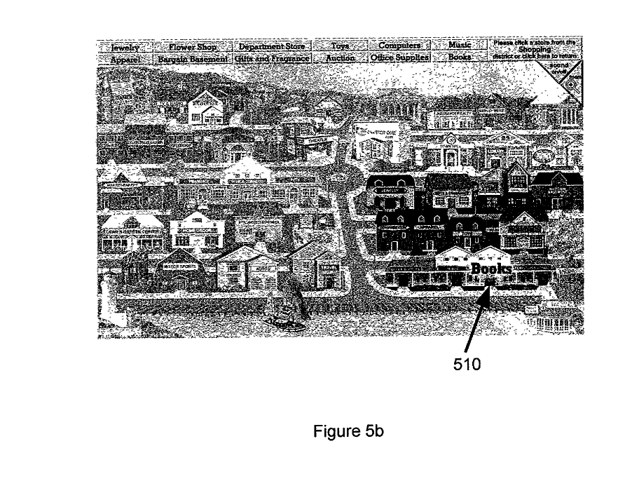

FIG. 5a illustrates an exemplary retail store in retail consumer district 425. District 425 contains information items dealing with books, toys, clothing, etc. In this illustrative example, building 510 is representative of bookstores within the town or village. Further illustrated is a change made to navigation bar 440 represented as navigation bar 440a when the user's cursor is placed over the district or the district is selected by some other means. In this illustrative example, navigation bar 440a displays categories associated with district 425. FIG. 5b illustrates a change to the exemplary web page illustrated in FIG. 5a when a cursor is placed over, for example, building 510. As illustrated, the specific information items contained in building 510 are clearly displayed, as represented by the word “Books.”

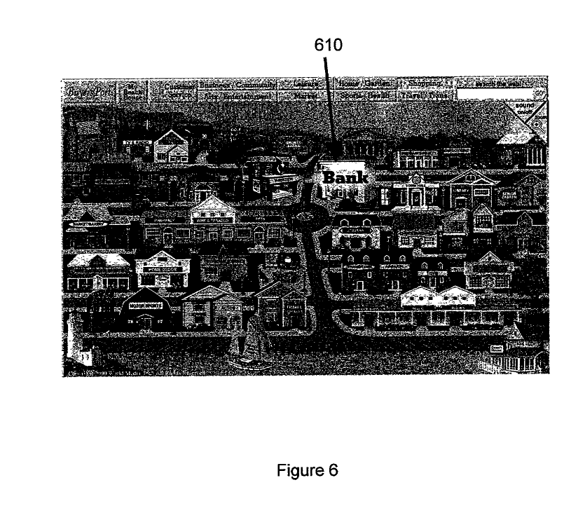

FIG. 6 illustrates a second illustrative example of displaying the specific information items contained in a particular building within a district. In this illustrative example, exemplary establishments associated with a business district are displayed when a cursor is placed over one specific building. For example, building 610 is associated with “banking” functions and is denoted by the overlaid word “Bank.”

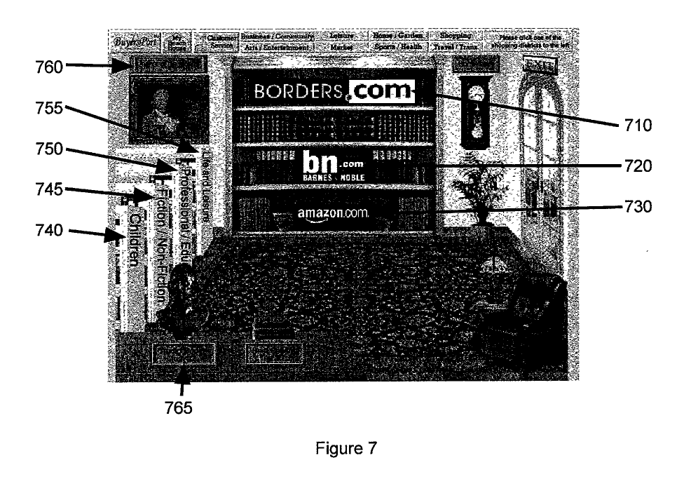

FIG. 7 illustrates an exemplary web site page representative of book establishments accessible from building 510 of FIG. 5a. In this illustrative example, building 510 contains hyperlinks to selected affiliated stores that sell or promote books on the Internet. For example, Borders.com 710, Barnes&Noble.com 720 and Amazon.com 730 are illustrated and are well known in the art as booksellers. FIG. 7 further illustrates categories of books such as Children 740, Fiction/Non-Fiction 745, Professional/Education 750, Life and Leisure 755, etc., represented on book shelves. The book shelves are selectable by a user to navigate to specific books within the labeled categories. Further illustrated are designated areas 760 and 765, which enable a user to navigate to designated information items, such as selected authors and selected audio books, respectively.

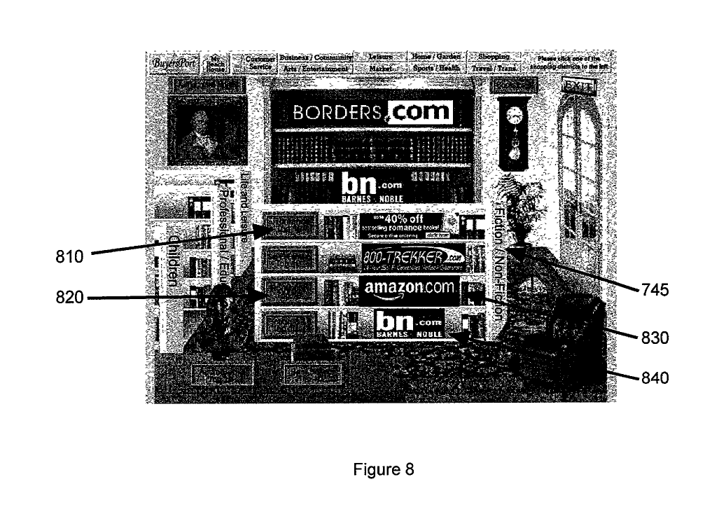

FIG. 8 illustrates an exemplary category, for example, Fiction/Non-Fiction 745, web site page which is viewed when selected by a user. In accordance with the principles of the invention, book retailers of Fiction/Non-Fiction books are grouped together to provide a single presentation to a user. For example, images representative of book retailers selling fiction/non-fiction books, such as Amazon.com 830 and Barnes&Noble.com 840, are illustrated within the bookcase shelves. Further illustrated are designated areas that are representative of specific categories, such as Romance 810. Romance category 810 is used to direct a user to selected information items corresponding to, for example, the top ten romance books under Fiction/Non-Fiction category 745.

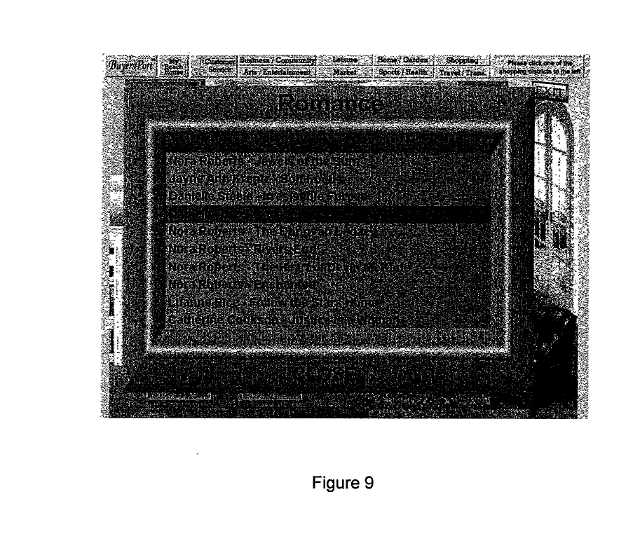

FIG. 9 illustrates an exemplary web site page depicting an exemplary top ten listing of books within, for example, romance category 810.

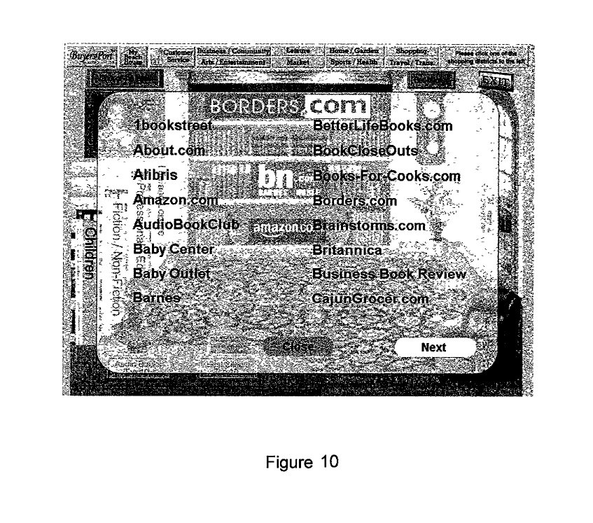

FIG. 10 illustrates a second exemplary embodiment of a web site page in accordance with the present invention. In this illustrative embodiment, a textual listing of retail or commercial establishments is displayed to the user. In this embodiment, the user is able to navigate to a selected retailer using the displayed list of retailers.

Accordingly, after linking through the selected retailer's web site pages, the user can immediately return to the store home page to begin linking to another selected retailer's web site pages. Thus, the user can easily return to the displayed retailers depicted in the selected store from a deep-link within a selected retailer's web site.

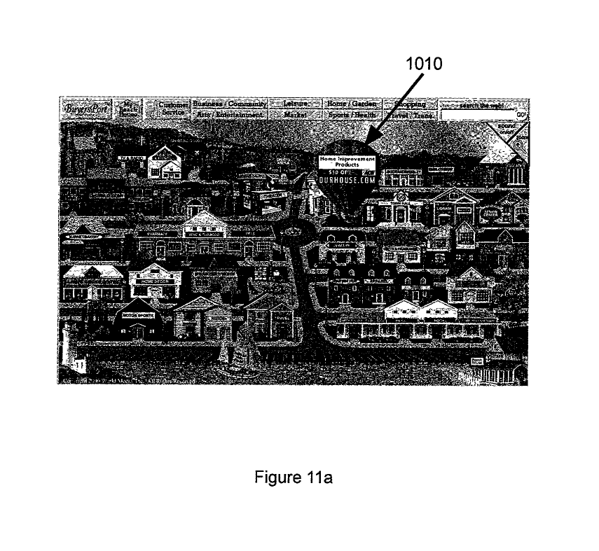

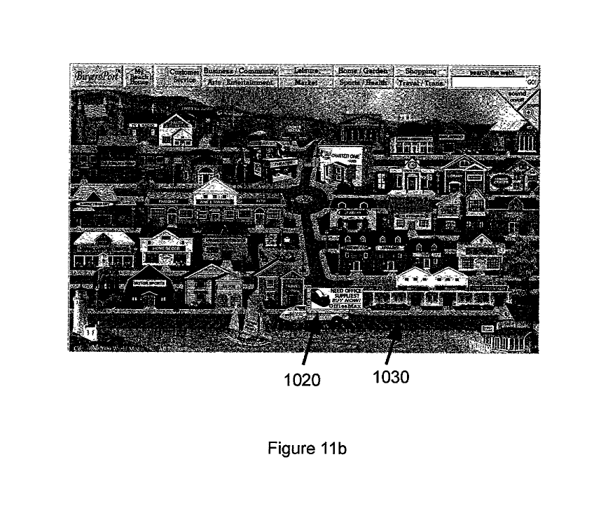

FIG. 11a illustrates another exemplary embodiment of the invention. In this embodiment, images are temporarily introduced onto the town or village web site page. Temporary images, such as balloon 1010 are animated movies that are displayed moving across the town or village image. In the alternative, temporary images, such as balloons 1010 are introduced, statically, at random locations within the town or village web site page and remain visible for a known period of time.

FIG. 11b illustrates a second exemplary embodiment of an image temporarily introduced onto the town or village. In this example, truck 1020 is depicted moving along a road 1030 in town. Such temporary images may, for example, carry advertisements for affiliated retail and commercial establishments, and may further contain hyperlinks to those establishments.

While there have been shown and described and pointed out fundamental novel features of the present invention as applied to preferred embodiments thereof, it will be understood that various omissions and substitutions and changes in the methods described and in the form and details of the devices disclosed, and in their operation, may be made by those skilled in the art without departing from the spirit of the present invention. For example, it is expressly intended that all combinations of those elements and/or method steps which perform substantially the same function is substantially the same way to achieve the same results are within the scope of the invention. Substitutions of elements from one described embodiment to another are also fully intended and contemplated. Examples of retail establishments used in the description of the invention are exemplary only and are not meant to limit the invention thereto.

1. A method of organizing and displaying a plurality of hyperlink addresses associated with a plurality of corresponding web site pages on a portal page comprising the steps of:
providing a visual representation of a map having a plurality of active areas thereon, said active areas representing individual hyperlinks or a plurality of hyperlinks having a common theme; and
modifying said map to provide information regarding said common theme when a cursor is placed over one of said active areas.

2. The method of claim 1 further comprising the step of:
grouping said active areas such that active areas related by a common concept are placed on said map in close proximity to each other

3. The method of claim 1 wherein said active areas are shown as representations of buildings on said map.

4. The method of claim 3 further comprising the steps of:
displaying the interior of a building when said active area represented by said building is selected; and
displaying said plurality of hyperlinks having a common theme on the interior of said building.

5. The method of claim 1 further comprising the step of:
displaying a button which, when selected by a user, will re-display said map, without regard to where said user has navigated.

6. The method of claim 1 further comprising the step of:
displaying a navigation bar having a plurality of buttons corresponding to said plurality of active areas on said map.

7. The method of claim 1 further comprising the step of:
temporarily displaying static images at random locations on said map.

8. The method of claim 7 wherein said images contain hyperlinks to web pages.

9. The method of claim 1 further comprising the step of: temporarily displaying images which appear to move across said map.

10. The method of claim 9 wherein said images contain hyperlinks to web pages.

11. The method of claim 1 wherein said plurality of web site pages associated with said plurality of hyperlink addresses are culturally localized.

12. The method of claim 11 further comprising the step of customizing said visual representation to provide a cultural theme, said cultural theme being associated with said plurality of culturally localized web site pages.

13. The method of claim 1 2 further comprising the step of providing a link which, when activated, displays a listing of one or more other portal pages, each of which has a visual representation customized for a different culture

14. A user interface for organizing and displaying a plurality of hyperlink addresses associated with a plurality of corresponding web site pages comprising:
a visual representation of a map having a plurality of active areas thereon, said active areas representing individual hyperlinks or a plurality of hyperlinks having a common theme, wherein said map is modified to provide information regarding said common theme when a cursor is placed over one of said active areas.

15. The user interface of claim 14 wherein said active areas related by a common concept are placed on said map in close proximity to each other.

16. The user interface of claim 14 wherein said map represents a village and further wherein said active areas are shown as representations of buildings and other common structures typically found in a village.

17. The user interface of claim 16 further comprising a display of the interior of a building, which is shown when said active area represented by said building is selected, said display of said interior of a building displaying all hyperlinks having a common theme associated with said active area.

18. The user interface of claim 14 further comprising a button which, which selected by a user, will re-display said map, without regard to where said user has navigated.

19. The user interface of claim 14 further comprising a navigation bar having a plurality of buttons corresponding to said plurality of active areas on said map.

20. The user interface of claim 11 further comprising one or more static images which are temporarily displayed at random locations on said map.

21. The user interface of claim 20 wherein said images contain hyperlinks to web pages.

22. The user interface of claim 14 further comprising one or more moving images which are temporarily displayed on said map.

23. The user interface of claim 22 wherein said images contain hyperlinks to web pages on said Internet.

24. The user interface of claim 14 wherein said plurality of web site pages associated with said plurality of hyperlink addresses are culturally localized.

25. The method of claim 24 further comprising the step of customizing said visual representation to provide a cultural theme, said cultural theme being associated with said plurality of culturally localized web site pages.

26. The method of claim 25 further comprising the step of providing a link which, when activated, displays a listing of one or more other user interfaces, each of which has a visual representation customized for a different culture.

27. A method of accessing a plurality of web site pages by collecting, organizing and visually presenting representations of a plurality of hyperlink addresses associated with said web site pages, said method comprising:
displaying a plurality of buildings on a map layout wherein each of said buildings are representative of categories of information items having a common theme;
organizing each of said plurality of buildings into districts, said districts representative of a common concept among said buildings illustrated therein.

28. The method of claim 27 further comprising the step of:
modifying the appearance of said buildings when a cursor is place thereover.

29. The method of claim 27 wherein said modifying step comprises displaying information relating to said common theme.

30. The method of claim 27 wherein said buildings represent a plurality of commercial or retail establishments.

31. The method of claim 27 further comprising the step of displaying a navigation bar.

32. The method of claim 31 wherein said navigation bar dynamically changes based on the position and/or interaction of a cursor with respect to said districts.

33. The method of claim 27 further comprising the step of temporarily displaying static or moving images at random locations on said map.

34. The method of claim 33 wherein said images display advertisements for said commercial or retail establishments.

35. The method of claim 33 wherein said images contain hyperlinks to said commercial and retail establishments.

36. The method of claim 27 further comprising the step of providing a means for a user to return to said map display, without regard to where said user has navigated using said hyperlinks.

37. The method of claim 27 further comprising the step of displaying said hyperlinks in a textual fashion.

38. The method of claim 27 wherein said plurality of web site pages associated with said plurality of hyperlink addresses are culturally localized.

39. The method of claim 38 further comprising the step of customizing said map layout to provide a cultural theme, said cultural theme being associated with said plurality of culturally localized web site pages.

40. The method of claim 39 further comprising the step of providing a link which, when activated, displays a listing of one or more other map layouts, each of which is customized for a different culture.
